(19) United States
(12) Patent Application Publication
(10) Pub. No.: US 2014/0203095 A1
(43) Pub. Date: Jul. 24, 2014

(54) DEVICE FOR SELF-EXTRACTION OF VEHICLE

(71) Applicant: Shaul Shwartz, Even-Yehuda (IL)

(72) Inventor: Shaul Shwartz, Even-Yehuda (IL)

(21) Appl. No.: 14/239,791

(22) PCT Filed: Aug. 29, 2011
(86) PCT No.: PCT/IL11/00694

§ 371 Date: Feb. 20, 2014

Related U.S. Application Data
(60) Provisional application No. 61/377,967, filed on Aug. 29, 2010.

(51) Int. Cl. B60B 39/12

(52) U.S. Cl. CPC B60B 39/12
USPC 238/14

(57) ABSTRACT

A vehicle extraction device includes a track for insertion between a wheel of the vehicle and soft ground below the wheel. A ground-penetration head is connected to a leading end of the traction track. The ground-penetration head includes a plate for placement on an outer perimeter surface of the wheel and a fastening mechanism for attaching the plate to the wheel. Attaching the ground-penetration head to the wheel with the leading end facing an intended direction of rotation of the wheel and rotation of the wheel in the intended direction may insert the ground-penetration head and the track between the outer perimeter surface and the soft ground.

### FIELD OF THE INVENTION

The present invention relates to vehicle extraction. More particularly, the present invention relates to a device with a ground-penetrating head for enabling a vehicle to self-extract from soft ground.

### BACKGROUND OF THE INVENTION

A driver of a wheeled vehicle, and in particular of a relatively heavy motorized tired vehicle such as an automobile, truck, or bus, may occasionally face a situation in which one or more of the wheels of the vehicle have sunk into soft ground such as including mud, sand, or snow. Lack of traction between the wheel and the soft ground may make it difficult or impossible to extract the stuck vehicle by simply driving or maneuvering the vehicle. In addition, motion of the wheel in the soft ground may form a pit, further complicating extraction of the vehicle. In such cases, the vehicle may be towed or pushed out of the soft ground by another vehicle or device. Alternatively, another object may be inserted between one or more of the wheels (typically a wheel that provides propulsion for the vehicle) and the substance in which the wheel is stuck in order to provide traction. For example, common inserted objects include boards, or rugs or blankets.

Specialized devices have been described for enabling self extraction of vehicles. For example, Uzarski in DE 341213 describes a flexible wedge-like device whose leading end may be attached to special projections on a wheel of the vehicle. The wheel may then be operated so as to pull the device along the wheel's perimeter and between the wheel and the ground, thus lifting the wheel and providing traction. Goebel in U.S. Pat. No. 1,720,396 also describes a device with traction surface and attached wedge that can be manipulated to jam the traction surface under a tire. Coale (U.S. Pat. No. 3,708,117) describes a traction track with a tapered leading end for self insertion under a tire of the vehicle, Pine (U.S. Pat. No. 4,254,907) describes a portable traction track with curvature-limiting structure. Use of the devices described above may be difficult or inefficient when the wheel is sunk deeply into the soft ground.

It is an object of embodiments of the present invention to provide a device for vehicle self-extraction that facilitates extraction of the vehicle from soft ground under a variety of circumstances.

Other aims and advantages of embodiments of the present invention will become apparent after reading the present invention and reviewing the accompanying drawings.

### SUMMARY OF THE INVENTION

There is thus provided, in accordance with some embodiments of the present invention, a vehicle extraction device including: a track for insertion between a wheel of the vehicle and soft ground below the wheel; and a ground-penetration head connected to a leading end of the track, the ground-penetration head including a plate for placement on an outer perimeter surface of the wheel and a fastening mechanism for attaching the plate to the wheel, such that attaching the ground-penetration head to the wheel with the leading end facing an intended direction of rotation of the wheel and rotation of the wheel in the intended direction may insert the ground-penetration head and the track between the outer perimeter surface and the soft ground.

Furthermore, in accordance with some embodiments of the present invention, the fastening mechanism includes at least one pair of clips extending from substantially opposite lateral sides of the plate.

Furthermore, in accordance with some embodiments of the present invention, an outward-facing surface of each clip is contoured such that when the plate is attached to the wheel and is moved by rotation of the wheel between the soft ground and the outer perimeter surface, a force is generated that presses the clip against a side of the wheel.

Furthermore, in accordance with some embodiments of the present invention, an outward-facing surface of the plate is contoured such that when the plate is attached to the wheel and is moved by rotation of the wheel between the soft ground and the outer perimeter surface, a force is generated that presses the plate against the outer perimeter surface.

Furthermore, in accordance with some embodiments of the present invention, the outward-facing surface slopes outward from a leading end of the plate.

Furthermore, in accordance with some embodiments of the present invention, wherein at least a portion of the track thickens with distance from the leading end.

Furthermore, in accordance with some embodiments of the present invention, a leading portion of the track adjacent to the leading end has a substantially constant thickness.

Furthermore, in accordance with some embodiments of the present invention, an inward-facing surface of the head or track includes structure for increasing traction between the device and the wheel.

Furthermore, in accordance with some embodiments of the present invention, the structure includes a plurality of projections.

Furthermore, in accordance with some embodiments of the present invention, a trailing end of the track includes an anchor for inhibiting motion of the track when the anchor engages the ground.

Furthermore, in accordance with some embodiments of the present invention, the track includes: an outer section with a leading end that is connected to the ground-penetration head and a trailing end that includes an anchor for inhibiting motion of the outer section when the anchor engages the ground; and an inner section having an outer surface that is configured to longitudinally slide with respect to the outer section, and an inner surface that is configured to provide traction between the inner section and the wheel.

Furthermore, in accordance with some embodiments of the present invention, the outer section includes a first pawl for engaging a second pawl on the inner section such that when the first pawl engages the second pawl, relative motion between the outer section and the inner section is inhibited.

Furthermore, in accordance with some embodiments of the present invention, the device includes a restraining mechanism for initially restraining motion of the inner section.

Furthermore, in accordance with some embodiments of the present invention, the restraining mechanism includes a restraining device for holding an end of a rope that is connected to the inner section and for releasing the end of the rope when a tension of the rope is increased beyond a predetermined tension.

Furthermore, in accordance with some embodiments of the present invention, the trailing end of the outer section includes a structure for engaging a widening at the leading end of the inner section, such that when the leading end of the outer section is pulled, the inner section is pulled as well.

Furthermore, in accordance with some embodiments of the present invention, the inner section includes a plurality of segments foldably connected to one another.

Furthermore, in accordance with some embodiments of the present invention, the device includes a plurality of segments that may be slid atop of or apart from one another.

Furthermore, in accordance with some embodiments of the present invention, each segment is configured to slide with respect to an adjacent segment when in contact with that adjacent segment, and to provide traction with respect to the wheel when in contact with the wheel.

There is further provided, in accordance with some embodiments of the present invention, a vehicle extraction device including a track for insertion between a wheel of the vehicle and soft ground below the wheel, an inward-facing surface of the track including structure for providing traction between the inward-facing surface and the wheel, and an outward-facing surface being smooth and including an anchor for engaging the ground at a trailing end of the track, at least a portion of the track increasing in thickness with distance from a leading end of the track.

Furthermore, in accordance with some embodiments of the present invention, a section of the track adjacent to the leading end, and whose length is substantially equal to one quarter of the distance between the leading end and the anchor, has substantially constant thickness.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 A shows a vehicle extraction device, in accordance with an embodiment of the present invention.

FIG. 1B shows another view of the vehicle extraction device shown in FIG. 1A.

FIG. 2 shows a cross sectional along a central longitudinal axis of a vehicle extraction device in accordance with an embodiment of the invention.

FIG. 3A illustrates attachment to a wheel of a ground-penetration head of a vehicle extraction device in accordance with an embodiment of the invention.

FIG. 3B illustrates a ground-penetration head with adjustable side clips, in accordance with an embodiment of the invention.

FIG. 4 illustrates side shields of a traction track of a vehicle extraction device in accordance with an embodiment of the invention.

FIG. 5A shows a vehicle extraction device with slidable sections, in accordance with an embodiment of the invention, as placed on an upper section of a wheel.

FIG. 5B shows the vehicle extraction device shown in FIG. 5A when rotated under the bottom of the wheel.

FIG. 5C shows a restraining mechanism associated with the vehicle extraction device shown in FIG. 5A.

FIG. 5D illustrates some details of the vehicle extraction device shown in FIG. 5A.

FIG. 6 shows a vehicle extraction device with a foldable inner section, in accordance with an embodiment of the invention, as placed partially folded on an upper section of a wheel.

FIG. 7A shows a vehicle extraction device with a collapsible inner section, in accordance with an embodiment of the invention, as placed on an upper section of a wheel.

FIG. 7B shows the vehicle extraction device shown in FIG. 7A when rotated under the bottom of the wheel.

FIG. 7C shows a transverse cross section through the vehicle extraction device shown in FIG. 7B.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

In accordance with an embodiment of the present invention, a vehicle extraction device includes a traction track with a ground-penetrating head connected to a leading end of the traction track. The ground-penetration head may be attached to a wheel of the vehicle, and can penetrate into soft ground when the wheel is rotated. The traction track is connected to the penetration head. The leading end of the traction track includes a high-traction surface at the side facing inward toward the wheel, and a low friction surface on the side facing outward toward the ground. The traction track may have a tapered or contoured profile, with its thickness increasing with distance from the leading end and the ground-penetration head.

The vehicle extraction device may be placed on the wheel arranged such that the leading end of the track faces an intended direction of rotation of the wheel. When so placed, the ground-penetration head may be attached to the wheel. If the wheel is then rotated in the intended direction, the ground-penetration head may drag or pull the traction track into soft ground between an outer perimeter of the wheel and the soft ground. As the traction track is pulled below the wheel, a thicker section of the traction track may lift the wheel, and its high-traction surface may facilitate extraction of the wheel from the soft ground. (References herein to inward-facing and outward-facing sides or surfaces, as well as leading and trailing ends, refer to surfaces and ends of the device or components of the device when the device is attached to or arranged on the wheel as described.)

The vehicle extraction device may be arranged along an outer perimeter surface of a wheel that is partially sunk into soft ground that includes a layer of a soft component such as mud, sand, or snow. For example, if the wheel is partially buried by the soft ground, the vehicle extraction device may be placed on an upper part of the wheel that is not buried.

The vehicle extraction device may be so arranged on the outer perimeter surface such that the ground-penetrating head is connected to leading end of the track, facing the intended direction of rotation of the wheel. The ground-penetrating head includes a head plate for placement over an outer perimeter surface of a vehicle tire or wheel.

The ground-penetrating includes a fastening mechanism for attaching the ground-penetrating head to the wheel. The fastening mechanism may keep the ground-penetrating head attached to the wheel at least until rotation of the wheel has caused the ground-penetrating head to penetrate into the ground. The fastening mechanism may include, for example, one or more clips, adhesive surfaces, wires, bands, straps, or pins. For example, the fastening mechanism may include side clips, where at least one side clip extends from each lateral side of the head plate. The side clips maybe designed to grasp the sides of the vehicle wheel near the outer perimeter, thus attaching the head plate to the wheel.

The head plate and side clips are so shaped such that when the ground-penetrating head is attached to the vehicle wheel as the leading end of the vehicle extraction device, rotation of the wheel in the intended direction causes the ground-penetrating head to penetrate into the soft ground and insert between the wheel and the soft ground. The head plate and side clips may also be shaped such that the penetration of the ground-penetrating head into the soft ground may exert a force that presses the head plate and side clips against the wheel. For example, such forces may be generated by motion of the ground-penetration head through the soft ground (e.g. due to fluid dynamic and hydrostatic forces). Pressing the head plate and side clips against the wheel may inhibit or prevent the vehicle extraction device from slipping or from separating from the wheel. Pressing the head plate and side clips against the wheel may also tend to increase friction or traction between the outer perimeter surface of the wheel and the vehicle extraction device.

Thus, with one or more vehicle extraction devices in accordance with an embodiment of the present invention arranged on and attached to one or more drive wheels of a vehicle, the vehicle may be operated. Operating the vehicle may rotate the drive wheel in the intended direction. Rotating the drive wheel in the intended direction may cause the ground-penetrating head to penetrate into the soft ground, inserting the ground-penetrating head and the attached traction track between the wheel and the soft ground. Further rotation of the wheel may pull the traction track toward the lowest (buried) section of the drive wheel. As the penetration head is brought lower below the wheel, more of the weight of the wheel and the vehicle is exerted on the traction track. Increasing the exerted weight may increase traction between the wheel and the inner surface of the traction track. At this point, the vehicle extraction device may provide sufficient traction, lift, or both, in order to enable further operation of the drive wheel to partially or fully propel the vehicle, thus extracting one or more wheels of the vehicle from the soft ground.

The term “wheel” should be understood herein as referring to any vehicle wheel, whether or not the wheel includes a tire. The outer perimeter surface of the wheel should be understood as referring to the surface of the wheel that is designed for contact with a roadway surface (and when the wheel includes a tire, is typically treaded), and may have a curved (typically convex) cross-sectional profile.

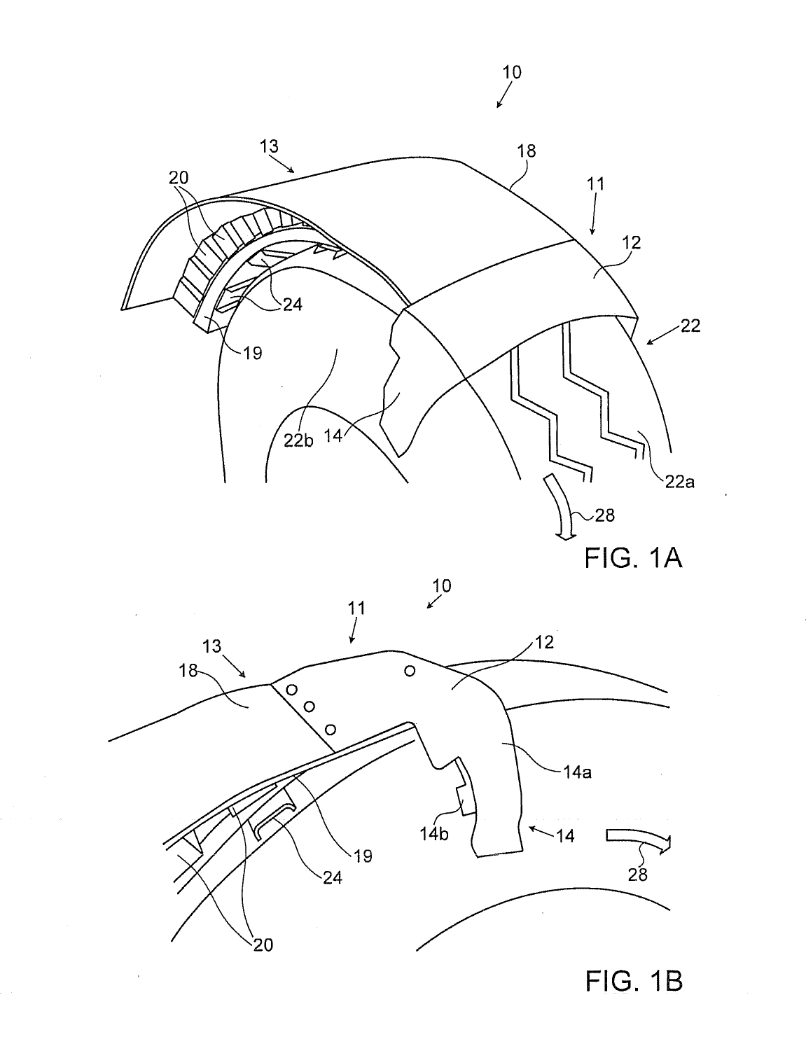

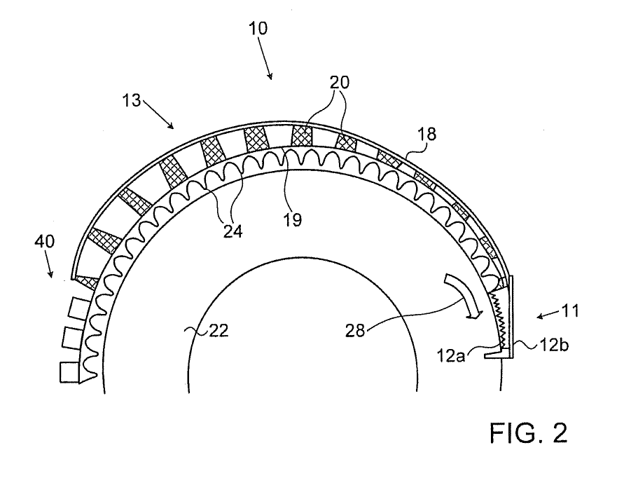

FIG. 1A shows a vehicle extraction device, in accordance with an embodiment of the present invention. FIG. 1B shows another view of the vehicle extraction device shown in FIG. 1A. FIG. 2 shows a longitudinal cross section of a vehicle extraction device in accordance with an embodiment of the invention.

Vehicle extractor device 10 is shown as mounted on an upper portion of wheel 22. For example, wheel 22 may represent a drive wheel of a vehicle that is partially buried in a soft ground.

Vehicle extractor device 10 includes ground-penetration head 11 and traction track 13. Ground-penetration head 11 includes head plate 12 and side clips 14 (only one is visible—vehicle extractor device 10 as shown is assumed to be substantially symmetric about its longitudinal axis).

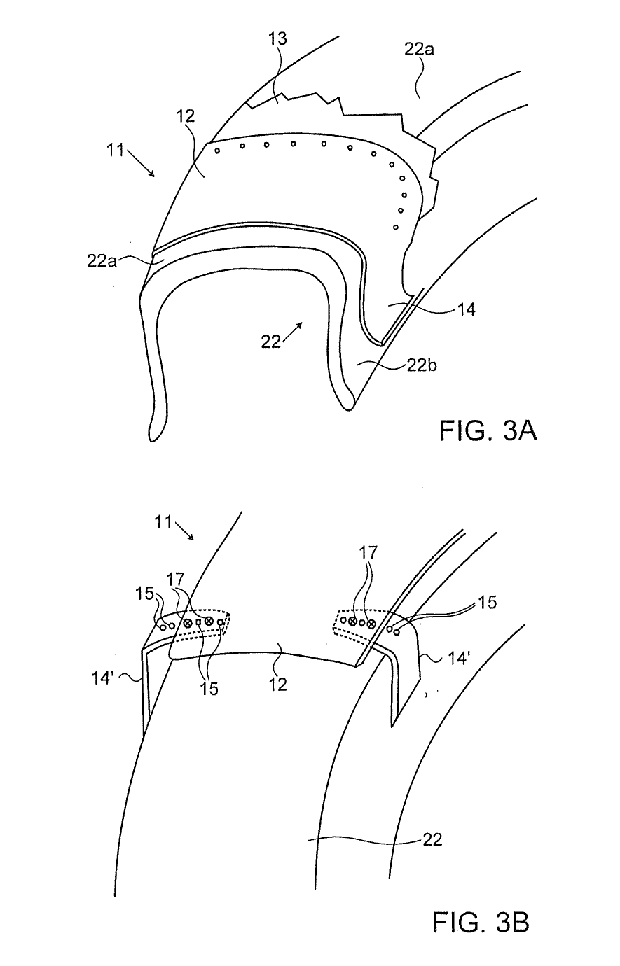

Head plate 12 of vehicle extractor device 10 is configured to fit on outer perimeter surface 22a of wheel 22. FIG. 3A illustrates attachment to a wheel of a ground-penetration head of a vehicle extraction device in accordance with an embodiment of the invention. An inward facing side 12a of head plate 12 (the side of head plate 12 that faces outer perimeter surface 22a of wheel 22) is typically sized and contoured so as to match and snugly fit outer perimeter surface 22a. For example, dimensions and contour shapes of head plate 12 may be designed for use with a particular model of wheel, or a particular group of similar wheel models. Head plate 12 attaches to a side clip 14 on either side of head plate 12 (only one is visible in FIGS. 1A and 1B—the other is symmetrically arranged on the opposite side of head plate 12). A snug fit between ground-penetration head 11 and wheel 22 may inhibit infiltration between ground-penetration head 11 and wheel 22 of a soft ground into which wheel 22 is sunk.

In accordance with an embodiment of the present invention, side clips of the ground-penetration head may be adjustable so as to fit a particular wheel. For example, the side clips may be configured to slide laterally such as to adjust a separation distance between the side clips. A mechanism may be provided for holding the side clips in place at the selected separation. For example, the mechanism may include clips, bolts, screws, pins, or ratchets.

FIG. 3B illustrates a ground-penetration head with adjustable side clips, in accordance with an embodiment of the invention. Adjustable side clips 14′ of penetration head 11 may include a series of holes 15. Head plate 12 may be provided with holes that are may be aligned with holes 15. By aligning a particular subset of holes 15 with the holes on head plate 12, a particular spacing between adjustable side clips 14′ may be selected. The selected alignment may be fixed by placing bolts 17 through the holes in head plate 12 and through the aligned holes 15.

Referring again to FIG. 2, inward-facing side 12a of head plate 12 may be further provided with projections. For example, the projections may be in the form of projecting ribs or studs. The projections may enhance traction between inward-facing side 12a and outer perimeter surface 22a.

Referring again to FIG. 1A, FIG. 1B, and to FIG. 2, outward-facing surface 12b of head plate 12 may be so shaped as to cause head plate 12 to be pressed against outer perimeter surface 22a when wheel 22 is rotated in the direction of arrow 28 into a soft ground. For example, a distance between outward-facing surface 12b and inward-facing side 12a may increase with distance from a leading end of head plate 12 from which side clips 14 extend. For example, outward-facing surface 12b may be provided with a sloping contour (e.g. a wedge shape or taper) such that motion through the soft ground in the indicated direction provides a normal force between head plate 12 and outer perimeter surface 22a. The shape of the sloping contour (e.g. wedge angle, taper slope, or angle of attack) may be selected so as to be sufficient (e.g. sufficiently steep) to provide the required normal force, but no so much (e.g. sufficiently gradual) as to provide excessive resistance to penetration into the ground. For example, a typical wedge angle may be about 15 degrees.

Each side clip 14 includes outer surface 14a. Outer surface 14a may be contoured (e.g. with a wedge-like or tapered profile) so as to provide a force that tends to press side clip 14 against side wall 22b of wheel 22 when wheel 22 is rotated in the direction indicated by arrow 28. Clip wall 14b is designed to grab side wall 22b when side clip 14 is pressed against wheel 22.

Further rotation of wheel 22 in the direction indicated by arrow 28 may lift ground-penetration head 11 out of the ground (e.g. at the other side of the wheel). At this point, the force pressing side clip 14 against side wall 22b may be reduced or absent. Reduction of the pressing force may enable easy removal of ground-penetration head 11 and vehicle extraction device 10 from wheel 22. For example, after being run over by the wheel, vehicle extraction device 10 may be somewhat stuck in the ground. Upon removal of the pressing force, vehicle extraction device 10 may remain on the ground as the vehicle drives away.

Traction track 13 may include inner and outer sheets that may be at least partially attached (e.g. at one or more regions or points along their lengths) to one another. At other regions or points of the sheets, the sheets may be unattached or separated from one another. For example, in accordance with an embodiment of the present invention, traction track may include outer track sheet 18 and inner track sheet 19. The outward-facing side of outer track sheet 18 and outward facing surface 12b of ground-penetration head 11 may be smooth or slippery as so to facilitate smooth penetration of ground-penetration head 11 and traction track 13 into the ground underneath the wheel. For example, outer track sheet 18 may be made out of or include a smooth flexible material, such as a plastic or metal sheet. Outer track sheet 18 may be further provided with anchor 40. When anchor 40 is pulled into the ground, anchor 40 may engage the ground. Engaging the ground may inhibit further motion of traction track 13. For example, anchor 40 may include projecting structure, e.g. in the form of ribs, studs, barbs, pegs, or hooked structure, for engaging the ground.

Inner track sheet 19 may be made of a flexible material and may be provided with structure that promotes traction between inner track sheet 19 and outer perimeter surface 22a of wheel 22. For example, the traction-promoting structure may include a material (e.g. rubber) whose coefficient of friction with respect to wheel 22 may be sufficiently large so as to promote traction. An inward-facing side (that faces wheel 22 when vehicle extraction device 10 is placed on wheel 22 as shown in FIG. 1A and in FIG. 2) of inner track sheet 19 may be provided traction-promoting structure in the form of projections 24 (e.g. including projecting ribs or studs, or including a textured or roughened surface) to further promote traction between inner track sheet 19 and outer perimeter surface 22a.

As shown in FIG. 2, outer track sheet 18 may be separated from inner track sheet 19 on outer perimeter surface 22a of wheel 22 by spacing ribs 20. For example, outer track sheet 18 and inner track sheet 19 may be connected only via a common connection to ground-penetration head 11. Spacing ribs 20 may be connected to inner track sheet 19 but not to outer track sheet 18. Outer track sheet 18 may be shorter than inner track sheet 19, exposing anchor 40 that is connected to inner track sheet 19.

A construction including spacing ribs 20 may enable traction track 13 to be flexible even at its thicker parts. Spacing ribs 20 may vary in height to as to achieve a desired thickness profile. For example, spacing ribs 20 that are further from ground-penetration head 11 may be taller than spacing ribs 20 that are closer to ground-penetration head 11. This gradual increase in height of spacing ribs 20 may cause the distance between outer track sheet 18 and outer perimeter surface 22a to increase with distance from ground-penetration head 11. The resulting wedge-like or ramp-like thickness profile of traction track 13 may lift wheel 22 upward (e.g. out of the ground) as wheel 22 rotates. The lifting action may aid in extracting wheel 22 from soft ground into which wheel 22 has sunk,

The thickness profile of traction track 13 may vary along the length of traction track 13. Typically, the thickness profile may be approximately flat (no increase in thickness) near the (leading) end of traction track that connects to ground-penetration head 11. A flat thickness profile may avoid additional resistance to penetration into the ground, thus facilitating pulling of traction track 13 into the ground. Enabling the penetration head 13 to penetrate further into the ground and under wheel 22 may increase a fraction of the weight of that wheel and the vehicle that is exerted on traction track 13, thus increasing traction between traction track 13 and wheel 22. The increased traction may facilitate pulling of a thickened portion of traction track 13 into the ground and under wheel 22.

The thickness profile of traction track 13 may thicken at a further distance from the leading end of traction track 13 that is connected to ground-penetration head 11. For example, the length of traction track 13 may be approximately equal to one half of the circumference of wheel 22. In this case, the thickening of traction track 13 may begin at a distance from the leading end that is approximately equal to one eighth of the circumference of wheel 22 (e.g. about one quarter of the distance from ground-penetration head 11 and anchor 40). For example, an angle describing a slope outer track sheet 18 relative to inner track sheet 19 may become gradually steeper from this point up to an angle of 20 degrees or more. A steep angle may enable greater thickening of the thickness profile, thus providing a greater (higher) lift of wheel 22 when the thickened portion of traction track 13 is below wheel 22.

At least an outward-facing side of outer track sheet 18 may be smooth or slippery, and reducing drag when penetrating into the ground. After traction track 13 is completely dragged under the wheel, anchor 40 stops its farther movement and it can facilitate extraction of wheel 22 out of a pit formed in the soft ground.

In accordance with an embodiment of the present invention, traction track 13 may be further provided with structure for preventing the soft ground, e.g. sand or mud, from infiltrating between inner track sheet 19 (or projections 24) and outer perimeter surface 22a of wheel 22 to where it could reduce traction.

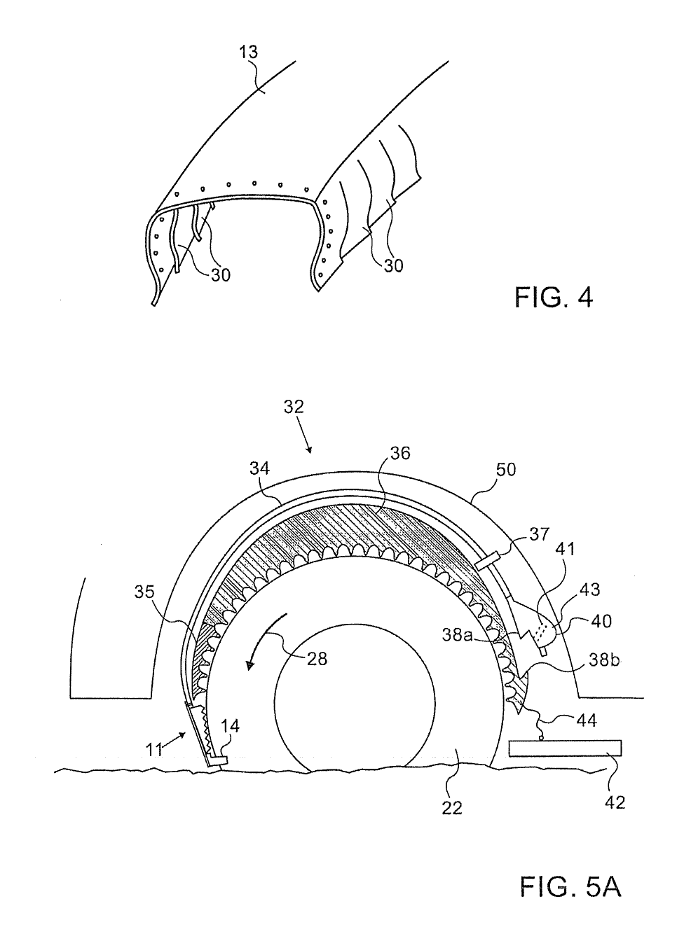

FIG. 4 illustrates side shields of a traction track of a vehicle extraction device in accordance with an embodiment of the invention. Traction track 13 is provided with side shields 30. Side shields 30 may be contoured to match a contour of a particular model or type of wheel. Each side shield 30 may partially overlap an adjacent side shield 30 in an imbricate manner. This overlap may enable traction track 13 to accommodate a curvature of a wheel while maintaining a seal to prevent influx or oozing of a soft ground into between traction track 13 and the wheel.

In accordance with some embodiments of the present invention, the extraction device may include a traction track without a penetration head. For example, a section of the track that is adjacent to a leading end of the traction track may be flat e.g. having a constant thickness. The section with constant thickness may be sufficiently long to enable the traction track be dragged by rotation of the wheel and to penetrate into the ground with minimal resistance. When the traction track is dragged to underneath the wheel, a sufficiently high traction may be created by the weight of the wheel and vehicle so as to drag a thickened section of the traction track into the ground and under the wheel. A typical length of the flat section may one quarter of the distance between the leading end of the traction track and an anchor at trailing end of the traction track.

In accordance with an embodiment of the present invention, a vehicle extraction device may include outer and inner sections that may longitudinally slide with respect to one another. The outer section may include a ground-penetration head and anchor. Rotation of a wheel on which the vehicle extraction device is placed may cause the outer section to may penetrate into the ground while a restraining mechanism delays the inner, traction- and lift-providing, section from rotating. Thus, penetration into the ground and provision of traction or lift are provided in separate stages of operation.

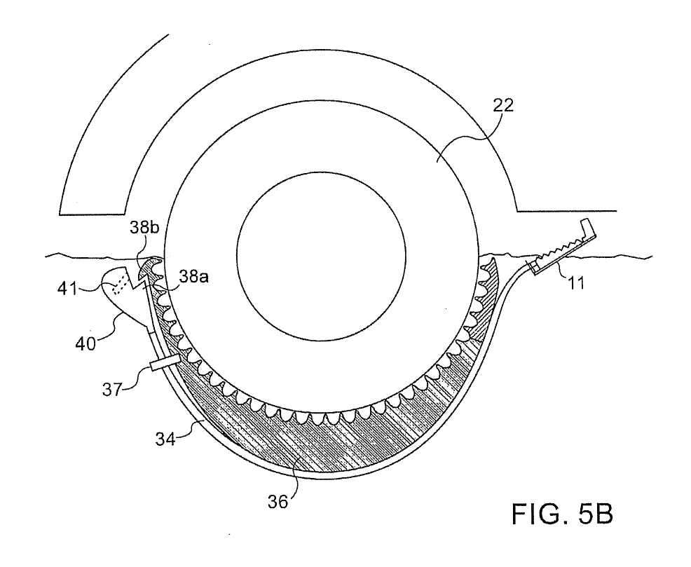

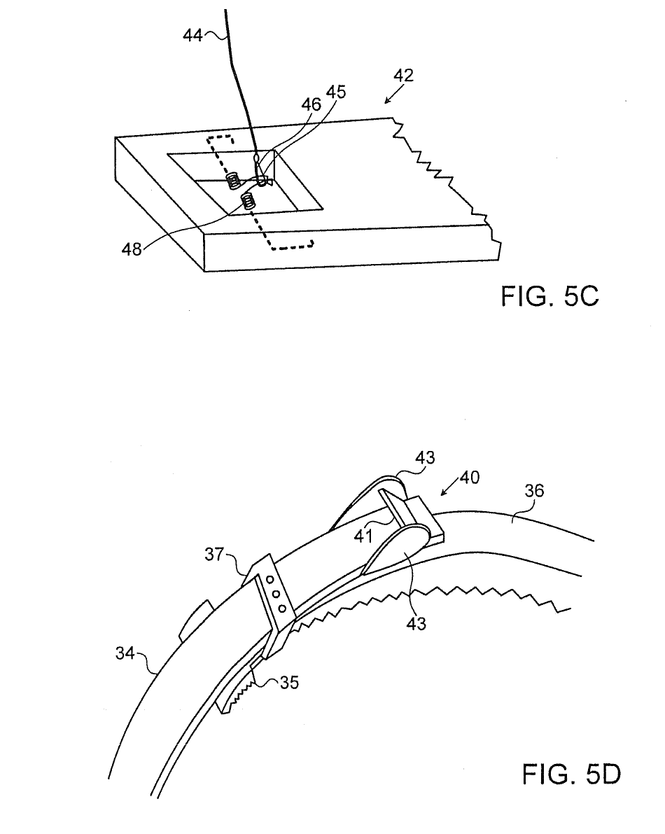

FIG. 5A shows a vehicle extraction device with slidable sections, in accordance with an embodiment of the invention, as placed on an upper section of a wheel. FIG. 5B shows the vehicle extraction device shown in FIG. 5A when rotated to the bottom of the wheel. FIG. 5C shows a restraining mechanism associated with the vehicle extraction device shown in FIG. 5A. FIG. 5D illustrates details of the vehicle extraction device shown in FIG. 5A.

Vehicle extraction device 32 includes outer section 34. One end (a leading end) of outer section 34 is connected to ground-penetration head 11, and a trailing end to anchor 40. Outer section 34 may be made of a smooth, self-lubricating, or otherwise slidable surface so as to minimize sliding friction between outer section 34 and inner section 36. Ground-penetration head 11, which may typically be designed for increased friction with wheel 22, may be pulled by rotation of wheel 22. Thus, rotation of wheel 22 in the direction indicated by arrow 28 may pull outer section 34 in that direction.

Anchor 40 includes structure, such as one or more sloped ribs 41, for engaging the ground. Once anchor 40 has engaged the ground, further rotation of wheel 22 may not further move outer section 34. Shields 43 may prevent sloped rib 41 from accidentally engaging vehicle surface 50 while being moved by wheel 22.

Inner section 36 may be constructed to maximize friction between inner section 36 and wheel 22. A thickness profile of inner section 36 may be tapered or shaped so as to lift wheel 22 as it is moved into the ground. A trailing end of inner section 36 may be attached via rope 44 (which may represent any suitable rope, cord, wire, ribbon, or string) to restraining device 42.

Thus, when vehicle extraction device 32 is initially placed over an upper section of wheel 22 (FIG. 5A), rotation of wheel 22 in the direction indicated by arrow 28 may cause ground-penetration head 11 to penetrate into the ground. Motion of ground-penetration head 11 into the ground pulls outer section 34 into the ground until anchor 40 engages the ground (FIG. 5B).

At first, movement of inner section 36 may be prevented or inhibited by rope 44 attached to restraining device 42. For example, restraining device 42 may be sufficiently heavy, or may be anchored to the ground or to the vehicle (e.g. held in place by a floor or bottom surface of the vehicle), so as to inhibit or prevent significant movement of restraining device 42. Rope 44 is attached (e.g. tied) to ring 46 which is placed around loop 45. Loop 45 may be held in a horizontal orientation by spring 48. Continued motion of wheel 22 may pull outer section 34 into the ground until engaging structure 37 of outer section 34, engages widened end 35 of inner section 36. Once engaging structure 37 has engaged widened end 35, further motion of outer section 34 may pull inner section 36 to below wheel 22. Sufficient tension force may then be applied on inner section 36, on rope 44, on ring 46, and on loop 45 so as to cause loop 45 to turn upward. When loop 45 has turned sufficiently upward, ring 44 may slip off of loop 45, removing the restraining of inner section 36.

A trailing end (i.e. a region of inner section 36 at the trailing end) of inner section 36 includes pawl 38b on a side facing outer section 34. Similarly, a trailing end (i.e. a region of outer section 34 near the trailing end) of outer section 34 includes pawl 38a on a side facing inner section 36. When inner section 36 is no longer restrained, rotation of wheel 22 moves inner section 36 until pawl 38b of inner section 36 engages pawl 38a of outer section 34, preventing further motion of inner section 36. At this point, inner section 36 may raise wheel 22 sufficiently and provide sufficient traction, to enable extraction of wheel 22 from the ground.

In accordance with an embodiment of the present invention, a vehicle extraction device with outer and inner sections that may longitudinally slide with respect to one another may include a foldable inner section. The foldable inner section may be initially folded so as to fit the vehicle extraction device on a relatively small section of a wheel, e.g. an upper section of wheel that is exposed above soft ground into which the wheel is partially sunk. The foldable inner section may be unfolded as the foldable inner section is pulled into the soft ground, thus raising the wheel and providing a sufficiently long traction track for extracting the wheel.

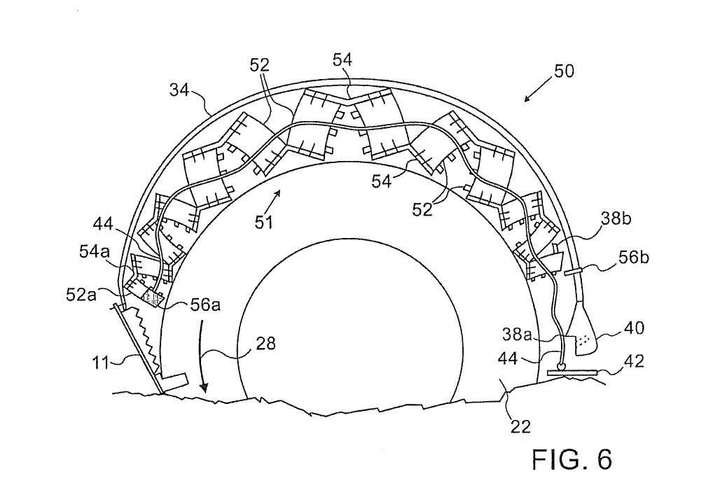

FIG. 6 shows a vehicle extraction device with a foldable inner section, in accordance with an embodiment of the invention, as placed partially folded on an upper section of a wheel.

Vehicle extraction device 50 includes outer section 34 and foldable inner section 51. Foldable inner section 51 includes segments 52. Each pair of adjacent segments 52 is connected by a flexible strip 54. For example, each segment 52 may be connected to one end of a flexible strip 54 using a suitable connector, such as screws or rivets. Alternatively, a foldable connection may be provided by hinges.

A leading segment 52a is provided a widened end 56a (the widening is perpendicular to the plane of the Figure, and is thus not visible). Engaging structure 56b (e.g. in the form of a pair of arms of suitable separation) that is designed to engage widened end 56a of foldable inner section 51 (e.g. similar to engaging structure 37 and widened end 35 shown in FIG. 5D) is located near a trailing end of outer section 34.

Aspects of operation of vehicle extraction device 50 are similar to operation of previously described vehicle extraction device 32 (FIGS. 5A-5D). When vehicle extraction device 50 may be initially placed over an upper section of wheel 22 with foldable inner section 51 in a folded state (flexible strips 54 are unfolded). Rotation of wheel 22 in the direction indicated by arrow 28 may cause ground-penetration head 11 to penetrate into the ground. Motion of ground-penetration head 11 into the ground pulls outer section 34 into the ground. Motion of foldable inner section 51 is initially prevented by rope 44 that connects leading segment 52a to restraining device 42.

When engaging structure 56b reaches widened end 56a, engaging structure 56b engages and pulls widened end 56a into the ground, releasing rope 44 from restraining device 42. Leading segment 52a may thus be straightened, folding leading flexible strip 54a. Rotation of wheel 22 continues to pull outer section 34 into the ground until anchor 40 engages the ground.

Rotation of wheel 22 then continues to pull foldable inner section 51 into the ground. Flexible strips 54 that connect adjacent segments 52 of foldable inner section 51 fold in turn as each pair of adjacent segments 52 is pulled into the ground. Foldable inner section 51 is continued to be pulled into the ground until pawl 38b of foldable inner section 51 engages pawl 38a of outer section 34, preventing further motion of foldable inner section 51. At this point, unfolded foldable inner section 51 may provide sufficient lift and traction to enable extraction of wheel 22 from the ground.

In accordance with an embodiment of the present invention, a vehicle extraction device may include a collapsible traction track. The collapsible traction track may include a plurality of segments (e.g. three) that in a collapsed state are stacked atop one another. The segments may be slide apart so as to penetrate the ground under the wheel one at a time. After the segments slide apart from one another, the segments may be stacked again below the wheel. The collapsible track may be initially collapsed so as to fit the vehicle extraction device on a relatively small section of a wheel, e.g. an upper section of wheel that is exposed above soft ground into which the wheel is partially sunk. The collapsible track may be thus be deployed by rotation of the wheel so as to raise the wheel sufficiently for extracting the wheel from the ground. An outermost segment may be configured (e.g. with smooth outer surface, ground-penetration head, or anchor) to serve at least part of the function of an outer section (e.g. outer section 34 in FIG. 5A). Alternatively, the vehicle extraction device may be provided with a separate outer section in addition to a collapsible inner section.

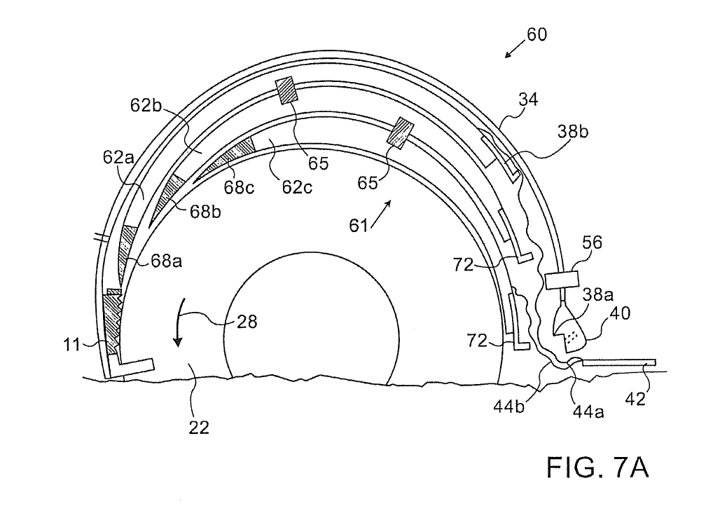

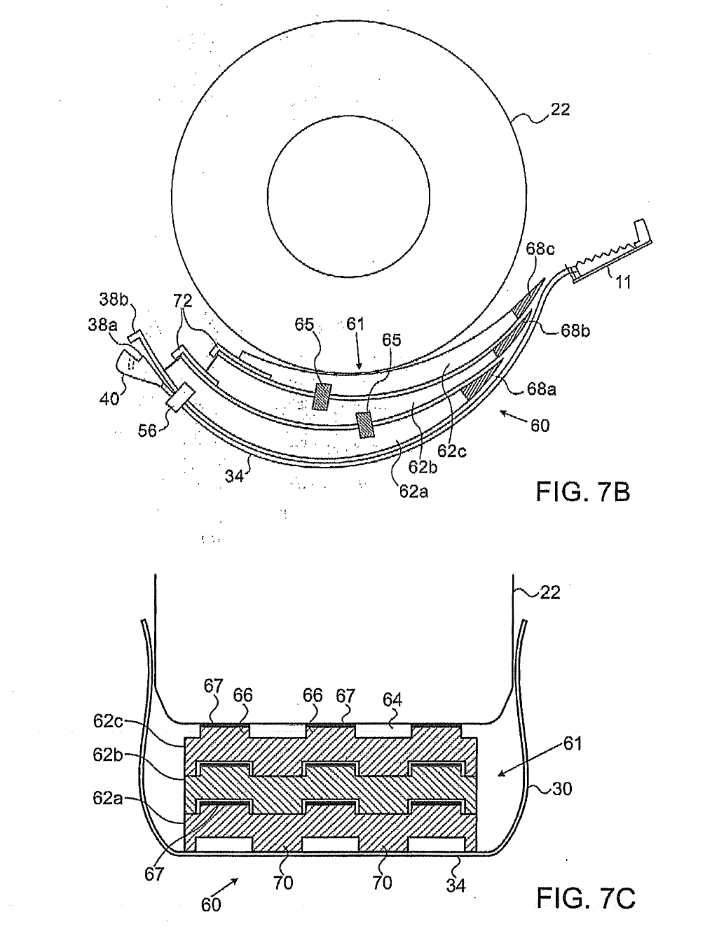

FIG. 7A shows a vehicle extraction device with a collapsible inner section, in accordance with an embodiment of the invention, as placed on an upper section of a wheel. FIG. 7B shows the vehicle extraction device shown in FIG. 7A when rotated to the bottom of the wheel. FIG. 7C shows a transverse cross section through the vehicle extraction device shown in FIG. 7B.

Vehicle extraction device 60 includes outer section 34 and collapsible inner section 61. Collapsible inner section 61 includes segments 62a, 62b, and 62c. Segments 62a, 62b, and 62c may be made identical to one another for ease of manufacturing.

Segments 62a, 62b, and 62c may be configured so as to slide over one another with minimal friction or resistance while providing traction with respect to wheel 22. For example, each segment 62a, 62b, or 62c may be constructed with alternating grooves 64, ridges 66, and spacing ridges 70. Grooves 64 and ends of spacing ridges 70 may be constructed with smooth or otherwise low-friction surfaces. Thus, segments 62a, 62b, and 62c may slide over one another. However, ridges 66, which are designed to contact wheel 22 when segments 62a, 62b, and 62c are deployed, may be provided with high-friction ends 67 (e.g. made of rubber or grooved). Thus, ridges 66 may provide traction with respect to wheel 22. Spacing ridges 70 are higher than ridges 66, so as to prevent contact between high-friction ends 67 of segments 62a or 62b and segments 62b or 62c above them.

As another example, for example if wheel 22 includes a rubber tire, an outward-facing surface of each segment may be provided with smooth surface and an inward-facing surface of each segment may be provided with a series of laterally oriented (perpendicular to a longitudinal axis from a leading end of the vehicle extraction device to a trailing end) or diagonally oriented ridges and grooves. The ridges may be configured (e.g. with smooth surfaces) so as to slide along an outward-facing surface of an adjacent segment with minimum resistance. For example, a smooth surface of the adjacent segment may slide along the ridges without interacting with the grooves. However, when in contact with a tire surface, the flexible surface of the tire may at least partially enter into the grooves (e.g. due to the weight of the vehicle). When the tire surface enters the grooves, rotation of the tire may pull the segment along with the tire.

Aspects of operation of vehicle extraction device 60 are similar to operation of previously described vehicle extraction device 32 (FIGS. 5A-5D). Vehicle extraction device 60 may be initially placed over an upper section of wheel 22 with collapsible inner section 61 in a collapsed state (segments 62a, 62b, and 62c are positioned or stacked atop one another). The collapsed state may enable placement of vehicle extraction 60 completely on an exposed upper section of wheel 22.

Each of segments 62a, 62b, and 62c is provided with a widened front end 68a, 68b, and 68c, respectively (e.g. similar to widened end 35 shown in FIG. 5D). A trailing end of outer section 34 includes an engaging structure 56 that is designed to engage widened front end 68a, but not widened front ends 68b and 68c (e.g. similar to engaging structure 37 shown in FIG. 5D). Each of segments 62a and 62b is provided with an engaging structure 65 for engaging widened front ends 68b and 68c, respectively.

Rotation of wheel 22 in the direction indicated by arrow 28 may cause ground-penetration head 11 to penetrate into the ground. Motion of ground-penetration head 11 into the ground pulls outer section 34 into the ground. Motion of segment 62a is initially prevented by rope 44a that connects segment 62a to restraining device 42. Similarly, motion of segment 62b may be initially prevented by rope (not shown) that connects segment 62b separately to restraining device 42. Similarly, motion of segment 62c is initially prevented by rope 44b that connects segment 62c separately to restraining device 42.

When engaging structure 56 reaches widened front end 68a, engaging structure 56 engages and pulls widened end 68a, thus pulling segment 62a. Rope 44a may be released from restraining device 42, enabling outer section 34 to pull segment 62a into the ground. Ridges 66 of segment 62a may be pressed against wheel 22. Thus, traction may be created between segment 62a and wheel 22, with low or minimal friction between spacing ridges 70 of segment 62a and outer section 34. Thus, wheel 22 may drag segment 62a into the ground.

Rotation of wheel 22 may continue to pull outer section 34 into the ground until anchor 40 engages the ground. Rotation of wheel 22 may continue to pull segment 62a, causing engaging structure 65 of segment 62a to engage and pull widened front end 68b of segment 62b. Continued movement of segment 62a may then continue to pull segment 62b. A rope (not shown) that connects segment 62b with restraining device 42 may then be released from restraining device 42. Engaging structure 65 of segment 62b may engage and pull widened front end 68c of segment 62c. Rope 44b may be released from restraining device 42, enabling segment 62c to be further dragged beneath wheel 22.

Rotation of wheel 22 may continue to pull segments 62a, 62b, and 62c into the ground until pawl 38b of segment 62a engages pawl 38a of outer section 34, preventing further motion of segment 62a. Segment 62b may continue to be dragged until its pawl 72 engages structure at the trailing end of segment 62a. Segment 62c may continue to be dragged extended until its pawl 72 engages structure at the trailing end of segment 62b. At this point, deployed collapsible inner section 61 may provide sufficient lift and traction to enable extraction of wheel 22 from the ground (as shown in FIG. 7B).

1. A vehicle extraction device comprising:
a track for insertion between a wheel of the vehicle and soft ground below the wheel; and
a ground-penetration head connected to a leading end of the track, the ground-penetration head including a plate for placement on an outer perimeter surface of the wheel and a fastening mechanism for attaching the plate to the wheel, such that attaching the ground-penetration head to the wheel with the leading end facing an intended direction of rotation of the wheel and rotation of the wheel in the intended direction may insert the ground-penetration head and the track between the outer perimeter surface and the soft ground.

2. The device of claim 1, wherein the fastening mechanism includes at least one pair of clips extending from substantially opposite lateral sides of the plate.

3. The device of claim 2, wherein an outward-facing surface of each clip is contoured such that when the penetration head is attached to the wheel and is moved by rotation of the wheel between the soft ground and the outer perimeter surface, a force is generated that presses the clip against a side of the wheel.

4. The device of claim 1, wherein an outward-facing surface of the plate is contoured such that when the plate is attached to the wheel and is moved by rotation of the wheel between the soft ground and the outer perimeter surface, a force is generated that presses the plate against the outer perimeter surface.

5. The device of claim 4, wherein the outward-facing surface slopes outward from a leading end of the plate.

6. The device of claim 1, wherein at least a portion of the track thickens with distance from the leading end.

7. The device of claim 6, wherein a leading portion of the track adjacent to the leading end has a substantially constant thickness.

8. The device of claim 1, wherein an inward-facing surface of the ground-penetration head or track includes structure for increasing traction between the device and the wheel.

9. The device of claim 8, wherein the structure includes a plurality of projections.

10. The device of claim 1, wherein a trailing end of the track includes an anchor for inhibiting motion of the track when the anchor engages the ground.

11. The device of claim 1, wherein the track comprises:
an outer section with a leading end that is connected to the ground-penetration head and a trailing end that includes an anchor for inhibiting motion of the outer section when the anchor engages the ground; and
an inner section having an outer surface that is configured to longitudinally slide with respect to the outer section, and an inner surface that is configured to provide traction between the inner section and the wheel.

12. The device of claim 11, wherein the outer section includes a first pawl for engaging a second pawl on the inner section such that when the first pawl engages the second pawl, relative motion between the outer section and the inner section is inhibited.

13. The device of claim 11, comprising a restraining mechanism for initially restraining motion of the inner section.

14. The device of claim 13, wherein the restraining mechanism comprises a restraining device for holding an end of a rope that is connected to the inner section and for releasing the end of the rope when a tension of the rope is increased beyond a predetermined tension.

15. The device of claim 11, wherein the outer section includes a structure for engaging a widening at the leading end of the inner section, such that when the leading end of the outer section is pulled, the inner section is pulled as well.

16. The device of claim 11, wherein the inner section comprises a plurality of segments foldably connected to one another.

17. The device of claim 1 comprising a plurality of segments that may be slid atop of or apart from one another.

18. The device of claim 17, wherein each segment is configured to slide with respect to an adjacent segment when in contact with that adjacent segment, and to provide traction with respect to the wheel when in contact with the wheel.

19. A vehicle extraction device comprising a track for insertion between a wheel of the vehicle and soft ground below the wheel, an inward-facing surface of the track including structure for providing traction between the inward-facing surface and the wheel, and an outward-facing surface being smooth and including an anchor for engaging the ground at a trailing end of the track, at least a portion of the track increasing in thickness with distance from a leading end of the track.

20. The device of claim 19, wherein a section of the track adjacent to the leading end, and whose length is substantially equal to one quarter of the distance between the leading end and the anchor, has substantially constant thickness.
